(19) United States
(12) Patent Application Publication
(10) Pub. No.: US 2011/0262337 A1
(43) Pub. Date: Oct. 27, 2011

(54) MEHTOD FOR ELIMIINATING BORON IMPURITIES IN METALLURGICAL SILICON

(76) Inventor: Guanghui JIANG, Xiamen (CN)

(21) Appl. No.: 12/184,242

(22) Filed: Jul. 31, 2008

(30) Foreign Application Priority Data
Jun. 6, 2008 (CN) 200810071194.9

(51) Int. Cl. C01B 33/037

(52) U.S. Cl. 423/348

(57) ABSTRACT

The present invention discloses a method for eliminating boron impurities in metallurgical silicon which includes the following steps: the metallurgical silicon powders being immersed in acid for 6˜48 hours is then washed and heatedly dried; silicon powders being acid cleaned, washed and heated in the first step is heated to 300° C.˜700° C. in the reactor and fed in oxidizing gas for oxidation reaction, wherein the reaction time is 6˜72 hours. The Silicon powders being heatedly oxidized are immersed in water or acid for 1˜6 hours and then washed clean; the silicon powders being immersed and washed is baked at 100° C. ˜300° C. for 6˜24 hours; whereas the metallurgical silicon purification art of the present invention is done at lower temperature, the operation is easier while lowering down the purification cost to provide good material for next work steps thereby satisfying the demands for low cost solar grade polycrystalline silicon productions.

### BACKGROUND OF THE INVENTION

(a) Field of the Invention

The present invention is related to a purification art for metallurgical silicon material, more particularly to a method for eliminating boron impurities in metallurgical silicon.

(b) Description of the Prior Art

As people have discovered the rapid reduction of fossil energy resources and the simultaneously serious pollutions of using fossil energy, mankind is actively developing environmental and renewable energies. At present, the renewable green energies that have entered human lives include solar energy and wind power, etc. wherein solar energy is the one most valued by mankind, as it has been well realized in developed countries. Silicone material is the widest applied plate material for solar cell, wherein silicone material can be divided by usage into two types: electronic grade and solar grade. Currently, solar cell is mainly made by using electronic grade scraping material or leftover material, whereas such material is less although a large quantity of silicone material is required for manufacturing solar cells, the development of solar energy industry is therefore somewhat significantly constrained by this factor. Due to insufficient supply to meet the demand for silicone material so as to let common people enjoy the fruits of solar energy technology. The researchers has been looking for a low cost method for producing silicone material for solar cells, wherein the most invested and researched method for purifying the solar grade polycrystalline silicone is the new metallurgy method (or alternatively called as physical method).

The concept of purification is mentioned in CN1628076A, wherein there are metal and non-metal impurities in silicone, the metal impurities include iron, aluminum, calcium, and copper, etc, whereas their separation coefficient are smaller, they can be reduced to very low level by several times of directional solidifications. However, for elements such as boron and phosphor having larger separation coefficients are difficult to be eliminated by the directional solidification method, hence, they can only be eliminated by other methods. The method for boron elimination such as the slagging and plasma method mentioned in CN1628076A is that silicone is first melt down, and then boron is eliminated by slagging and plasma method, wherein the concern is that high temperature causes safety hazards easily and bigger quantity of slag formation is required.

The inventor is mainly purposed to disclose a method for eliminating borons in silicone material, wherein a special method is disclosed to purify metallurgical silicone using principles of metallurgy, and in considering the difficulties of high temperature operations, it is an easier method for eliminating boron in silicone at lower temperature and simultaneously achieves the target of lowering down the invention cost while satisfying the demand for low cost solar grade polycrystalline silicones and thus the application for patent is made.

### SUMMARY OF THE INVENTION

The present invention is purposed to solve the disadvantages of difficult impurities removal and high cost of existing solar grade polycrystalline silicone purification art by disclosing a simple and lower cost method for eliminating boron impurities in metallurgical silicon being able to eliminate boron impurities in silicones at lower temperature.

To achieve said purpose, the technical method of the present invention is described in the following:

A method for eliminating boron impurities in metallurgical silicon includes the following steps:

First step, acid cleaning: metallurgical silicon powders being immersed in acid for 6˜48 hours is then washed and heatingly dried;

Second step, heating oxidation: silicon powders being acid cleaned, washed and heated in the first step is heated to 300˜700 degree C. in the reactor and fed in oxidizing gas for oxidation reaction, wherein the reaction time is 6˜72 hours;

Third step, immersion: silicon powders being heatingly oxidized in the second step is immersed in water or acid for 1˜50 hours and then washed clean;

Fourth step, baking: the silicon powders being immersed and washed is baked at 100˜300 degree C. for 6˜24 hours.

The silicone powders of 50˜2000 meshes as described in the first step can be directly purchased in the market or can be obtained by breaking the metallurgical silicone material in the powder grinding mill to 50˜2000 meshes, wherein said metallurgical silicone material can be purchased or made from metal silicones, and the powder grinding mill can be one or several kinds of the grinders of broad sense, ball grinders, micropowder grinding mills, or ordinary powder grinding mills, etc.

The acid used for acid cleaning as described in the first step can be one or several types of hydrochloric acid, sulfuric acid or acetic acid, wherein metal impurities in the silicone powders can be eliminated through acid cleaning.

One or several types of de-ionized water, distilled water or utility water can be adopted for washing the silicon powders after acid immersion in the first step and finally dried.

The said reactor as described in the second step is an enclosed, semi-enclosed or open container; the oxidizing gas is arbitrarily either type of air or oxygen; and simultaneously, the silicone powders shall be agitated during the oxidation reaction process so as to accelerate the reaction speed.

The water as described in the third step can be utility water or de-ionized water; the acid can be one or several types of hydrochloric acid, sulfuric acid or acetic acid, wherein the silicone powders after immersion is washed clean by water.

The principle of the present invention is that: the metal impurities in silicone powders are eliminated by acid cleaning; next, non-metal impurities such as boron in silicone powders are heatingly oxidized to become water or acid dissolvable oxides; and finally, the non-metal impurities such as boron in the silicone powders are eliminated. The advantageous effect of the present invention is that: as it is done at lower temperature, the operation is easier while lowering down the purification cost to provide good material for next work steps thereby satisfying the demands for low cost solar grade polycrystalline silicon productions.

The present invention along with specific embodiments is further described in the following:

### DETAIL DESCRIPTION OF THE PREFERRED EMBODIMENTS

### Embodiment 1

The self-made or purchased metal silicon block with 60 ppm boron content is broken in the grinding mill of broad sense to obtain 50˜80 mesh powders, then the 50 mesh silicon powders are immersed in acid for 6 hours to eliminate metal impurities, after that they are washed by ionized water; next, the washed silicon powder being heated in an oven to reach dryness are then put in an enclosed reactor being heated to 700 degree C. with oxygen gas supply but without agitation in the process for 72 hours thereby oxidizing the non-metal impurities such as boron to become water or acid dissolvable oxides. After that, the oxidized silicon powders being immersed in hydrochloric acid for 48 hours to eliminate oxides of non-metal impurities such as boron and washed by de-ionized water are baked at 200 degree C. thereby allowing the silicon powders to be dried after 6 hours. The boron content of the metal silicon is 44 ppm after said treatment.

### Embodiment 2

The 300 mesh silicon powders in embodiment 1 being immersed in acid for 12 hours to eliminate metal impurities are washed by utility water and then heated in the oven to reach dryness; next, the treated silicon powders are put in an enclosed reactor being heated to 500 degree C. with oxygen gas supply but without agitation in the process for 72 hours thereby oxidizing the non-metal impurities such as boron to become water or acid dissolvable oxides. After that, the oxidized silicon powders being immersed in hydrochloric acid for 6 hours to eliminate oxides of non-metal impurities such as boron and washed by de-ionized water are baked at 150 degree C. thereby allowing the silicon powders to be dried after 8 hours. The boron content of the metal silicon is 32 ppm after said treatment.

### Embodiment 3

The 500 mesh silicon powders in embodiment 1 being immersed in acid for 48 hours to eliminate metal impurities are washed by de-ionized water and then heated in the oven to reach dryness; next, the treated silicon powders are put in a semi-enclosed reactor being heated to 300 degree C. with air supply and being agitated in the process for 48 hours thereby oxidizing the non-metal impurities such as boron to become water or acid dissolvable oxides. After that, the oxidized silicon powders being immersed in aqua regia for 12 hours to eliminate oxides of non-metal impurities such as boron and washed by distilled water are baked at 150 degree C. thereby allowing the silicon powders to be dried after 8 hours. The boron content of the metal silicon is 28 ppm after said treatment.

### Embodiment 4

The self-made or purchased metal silicon block with 40 ppm boron content is broken in the ultra-fine micropowder grinding mill to obtain 500˜1200 mesh powders; then the 1200 mesh silicon powders are immersed in acid for 36 hours to eliminate metal impurities, after that they are washed by ionized water; next, the washed silicon powder being heated in an oven to reach dryness are then put in an open type reactor being heated to 450 degree C. with air supply but without agitation in the process for 6 hours thereby oxidizing the non-metal impurities such as boron to become water or acid dissolvable oxides. After that, the oxidized silicon powders being immersed in nitric acid for 36 hours to eliminate oxides of non-metal impurities such as boron and washed by de-ionized water are baked at 300 degree C. thereby allowing the silicon powders to be dried after 24 hours. The boron content of the metal silicon is 17 ppm after said treatment.

### Embodiment 5

The 800 mesh silicon powders in embodiment 4 being immersed in acid for 48 hours to eliminate metal impurities are washed by utility water and then heated in the oven to reach dryness; next, the treated silicon powders are put in a semi-enclosed reactor being heated to 300 degree C. with air supply and being agitated in the process for 48 hours thereby oxidizing the non-metal impurities such as boron to become water or acid dissolvable oxides. After that, the oxidized silicon powders being immersed in nitric acid for 14 hours to eliminate oxides of non-metal impurities such as boron and washed by distilled water are baked at 200 degree C. thereby allowing the silicon powders to be dried after 16 hours. The boron content of the metal silicon is 15 ppm after said treatment.

### Embodiment 6

The self-made or purchased metal silicon block with 60 ppm boron content is broken in an ordinary grinding mill to obtain 300˜600 mesh powders; then the 600 mesh silicon powders are immersed in acid for 36 hours to eliminate metal impurities, after that they are washed by ionized water; next, the washed silicon powder being heated in an oven to reach dryness are then put in an open type reactor being heated to 450 degree C. with air supply and being agitated in the process for 36 hours thereby oxidizing the non-metal impurities such as boron to become water or acid dissolvable oxides. After that, the oxidized silicon powders being immersed in aqua regia for 36 hours to eliminate oxides of non-metal impurities such as boron and washed by de-ionized water are baked at 300 degree C. thereby allowing the silicon powders to be dried after 24 hours. The boron content of the metal silicon is 20 ppm after said treatment.

### Embodiment 7

The self-made or purchased metal silicon block with 60 ppm boron content is broken in the ultra-fine micropowder grinding mill to obtain 300˜600 mesh powders; then the 600 mesh silicon powders are immersed in acid for 36 hours to eliminate metal impurities, after that they are washed by ionized water; next, the washed silicon powder being heated in an oven to reach dryness are then put in an open type reactor being heated to 450 degree C. with air supply and being agitated in the process for 36 hours thereby oxidizing the non-metal impurities such as boron to become water or acid dissolvable oxides. After that, the oxidized silicon powders being immersed in hydrofluoric acid for 26 hours to eliminate oxides of non-metal impurities such as boron and washed by de-ionized water are baked at 300 degree C. thereby allowing the silicon powders to be dried after 24 hours. The boron content of the metal silicon is 24 ppm after said treatment.

### Embodiment 8

The self-made or purchased metal silicon block with 60 ppm boron content is broken in the ultra-fine micropowder grinding mill to obtain 300˜600 mesh powders; then the 600 mesh silicon powders are immersed in acid for 36 hours to eliminate metal impurities, after that they are washed by ionized water; next, the washed silicon powder being heated in an oven to reach dryness are then put in an open type reactor being heated to 450 degree C. with air supply and being agitated in the process for 36 hours thereby oxidizing the non-metal impurities such as boron to become water or acid dissolvable oxides. After that, the oxidized silicon powders being immersed in aqua regia and hydrofluoric acid for 26 hours to eliminate oxides of non-metal impurities such as boron and washed by de-ionized water are baked at 300 degree C. thereby allowing the silicon powders to be dried after 24 hours. The boron content of the metal silicon is 18 ppm after said treatment.

1. A method for eliminating boron impurities in metallurgical silicon, including the following steps:
First step, acid cleaning: metallurgical silicon powders containing the boron impurities immersed in acid for 6˜48 hours is washed and heated dry;
Second step, heated oxidation: silicon powders being acid cleaned, washed and heated in the first step is heated to 300° C.˜700° C. in a reactor and fed in an oxidizing gas for oxidizing of 6˜72 hours;
Third step, immersion: silicon powders being heatedly oxidized in the second step is immersed in water or one or a mixture of aqua regia, hydrochloric acid, sulfuric acid or acetic acid for 1˜6 hours and then washed clean;
Fourth step, baking: the silicon powders being immersed and washed is baked at 100° C.˜300° C. for 6˜24 hours, wherein said boron impurities in said metallurgical silicon powders is further reduced by 10% when applying a mixture of aqua regia and hydrochloric acid than hydrochloric acid alone in said third step.

2. The method for eliminating boron impurities in metallurgical silicon as claimed in claim 1, wherein the particle sizes of silicon powders are between 50˜2000 meshes.

3. The method for eliminating boron impurities in metallurgical silicon as claimed in claim 2, wherein said metallurgical silicon powders are purchased or made from metal silicone by powder grinding mills including ball grinders, micropowder grinding mills, or ordinary powder grinding mills.

4. The method for eliminating boron impurities in metallurgical silicon as claimed in claim 1, wherein the acid used in the first step is one or several types of hydrochloric acid, sulfuric acid or acetic acid.

5. The method for eliminating boron impurities in metallurgical silicon as claimed in claim 1, wherein one or a mixture of de-ionized water, distilled water or utility water is used for cleaning the silicon powders after immersion in the acid in the first step.

6. The method for eliminating boron impurities in metallurgical silicon as claimed in claim 1, wherein said reactor is an enclosed, semi-enclosed or open container.

7. The method for eliminating boron impurities in metallurgical silicon as claimed in claim 1, wherein the oxidizing gas is air or oxygen.

8. The method for eliminating boron impurities in metallurgical silicon as claimed in claim 1, wherein the silicon powders are agitated during the heated oxidation.

9. The method for eliminating boron impurities in metallurgical silicon as claimed in claim 1, wherein the water in the third step is utility water or de-ionized water.

10. (canceled)
